(19) United States
(12) Patent Application Publication
(10) Pub. No.: US 2015/0216139 A1
(43) Pub. Date: Aug. 6, 2015

(54) Outdoor Pet Enclosure

(71) Applicant: William Drake, Cleburne, TX (US)

(72) Inventor: William Drake, Cleburne, TX (US)

(21) Appl. No.: 14/339,802

(22) Filed: Jul. 24, 2014

Related U.S. Application Data
(60) Provisional application No. 61/934,009, filed on Jan. 31, 2014.

(51) Int. Cl. A01K 1/03; A01K 1/035

(52) U.S. Cl. CPC A01K 1/034; A01K 1/035

(57) ABSTRACT

Described is an outdoor enclosure for a pet that can be secured to the exterior of a home and is accessible via a pet door disposed on the home. The enclosure is defined by a pair of opposing sidewalls, a front wall, an open rear wall to be positioned against an exterior of a home, and a top wall having a hinged lid. The walls and lid are preferably composed of a wire mesh screen. An adjustable horizontal support serves as the floor of the enclosure and can be disposed at a desired height therein. The perimeter of the open rear of the enclosure has a plurality of brackets adapted to receive fasteners therethrough. Additionally, the enclosure includes a pair of extendable legs. Thus, the present invention provides an outdoor pet enclosure in which a litterbox can be positioned in order to keep odors and litter outside of the home.

### CROSS REFERENCE TO RELATED APPLICATION

This application claims the benefit of U.S. Provisional Application No. 61/934,009 filed on Jan. 31, 2014, entitled “Open Air Litter Box.” The above identified patent application is herein incorporated by reference in its entirety to provide continuity of disclosure.

### BACKGROUND OF THE INVENTION

1. Field of the Invention

The present invention relates to an enclosure adapted to be secured to the exterior of a home or other building that allows a cat or other pet to exit the home and enter the enclosure positioned outside of the home. The enclosure is adapted to house a litterbox therein so that the litterbox odors and spilled litter does not create a mess inside of a home. Further, the enclosure allows an indoor pet to spend time outside of the home without the need for supervision by the pet owner.

Many pet owners keep their pets indoors so as to ensure the safety of their pets. When outdoors, pets are at risk of being physically injured and are at risk of getting fleas, ticks, and various illnesses. However, if the pet is required to stay indoors, the pet owner must provide the pet with a place to relieve itself within the home. Alternatively, the pet owner must let the pet outside whenever the pet must relieve itself, and the owner must supervise the pet and usher the pet back inside once the pet has relieved itself.

Cat owners generally provide their cats with a litterbox so as to provide the cat with a place to relieve itself within the home. Despite the use of odor-shielding or eliminating litter, foul odors may still permeate into the room in which the litterbox is located. Further, litter from the litterbox often spills out of the litterbox and onto the floor, creating a mess. Additionally, germs and bacteria are then released onto the floor and into the room. Thus, while the litterbox provides a convenient means for allowing the cat to relieve itself within the home, the litterbox may become unsanitary and may create an unpleasant odor if not thoroughly cleaned on a regular basis.

The present invention discloses an outdoor enclosure for pets. The enclosure comprises a first and second sidewall, a front wall connecting the first and second sidewalls, an open rear wall, a top wall, and an adjustable horizontal support that serves as the floor of the enclosure. The walls of the enclosure comprise a screen thereon. The adjustable horizontal support comprises a flat, solid rectangular panel on which a pet can stand and walk, and on which a litterbox can be positioned. The adjustable horizontal support comprises a plurality of hooks disposed about the perimeter thereof that can be engaged with the sidewalls and front wall of the enclosure so as to allow the user to adjust the height of the horizontal support within the enclosure. The enclosure further comprises a hinged lid disposed on the top wall that provides access to the interior volume of the enclosure so that the pet owner can remove and clean the litterbox therein. The enclosure additionally includes a pair of extendable legs that can be used to adjust the height of the enclosure above the ground. The enclosure is adapted to be secured to the exterior of a building and about a pet door on the building so that a pet can exit the building through the pet door, and enter the enclosure. Thus, the present invention provides an outdoor enclosure in which a litterbox can be positioned so as to allow the pet to relieve itself outdoors, preventing litter and foul odors from entering the home, and further allowing the pet to spend time outdoors.

2. Description of the Prior Art

Devices have been disclosed in the prior art that relate to animal enclosures. These include devices that have been patented and published in patent application publications. These devices generally relate to animal enclosures. The following is a list of devices deemed most relevant to the present disclosure, which are herein described for the purposes of highlighting and differentiating the unique aspects of the present invention, and further highlighting the drawbacks existing in the prior art.

One such device, U.S. Patent Application Publication Number 2010/0300371 to Oeltjen et al. discloses a modular pet enclosure having multiple flat panels secured together using connectors. Each panel has a rigid perimeter with a mesh screen thereon. The panels can be arranged so as to form pet enclosures having various configurations. Thus, while Oeltjen et al. discloses a pet enclosure, the device is not adapted to be secured to the exterior of a home or other building. Further, the device does not include an adjustable floor that can be disposed at various heights, nor does the device include extendable legs that can be adjusted to dispose the enclosure at a desired elevation above the ground.

Another device, U.S. Pat. No. 6,412,440 to Kobayashi discloses an elevated path for use with a litterbox. The path is adapted to be positioned so as to lead to the entrance of a litterbox. Thus, when the cat exits the litterbox, the litter remaining on the cat's paws will fall through apertures on the walkway so that the cat does not track the litter throughout the home. A tray is disposed beneath the walkway to catch any litter that falls through the apertures thereon, allowing for easy clean-up. Thus, Kobayashi discloses a path to a litterbox, and does not disclose a pet enclosure adapted to be secured to the exterior of a home.

U.S. Pat. No. 1,127,712 to Wrenn discloses a portable poultry house having separate units. The units include a skeleton steel-wire body or frame. The cage units have hinged tops that allow for access to the interior of the cages. Further, the cage units have openings that lead into a main house or to outside pens. Thus, while Wrenn discloses an outdoor enclosure for poultry, the device does not include an adjustable horizontal support that forms the floor of the enclosure. Further, the device does not include extendable legs that allow the enclosure to be disposed at a desired height.

U.S. Pat. No. 3,581,709 to Van Huis discloses a confinement cage having a mesh floor and a solid member extending between opposing sides of the cage. This solid member is positioned slightly above the cage floor and is secured to a second support member located therebeneath. The cage is supported by spaced members extending beneath the cage. Thus, Van Huis discloses an enclosure, but fails to disclose an enclosure securable to the exterior of a home, and does not disclose an adjustable horizontal support disposed within the interior of the enclosure.

Finally, U.S. Pat. No. 5,329,879 to Walton discloses a containment device for pets adapted to prevent the spread of litter. The device includes a fence that surrounds an animal's litterbox, and includes a ramp leading to the top border of the litterbox. Thus, Walton discloses a device to help a cat enter a litterbox and that helps litter from escaping the litterbox. Walton fails to disclose an enclosure in which a litterbox can be positioned, and that is adapted to be positioned outside of a home.

These prior art devices have several known drawbacks. Devices in the prior art generally disclose animal enclosures, but fail to disclose enclosures that can be secured to the exterior of a home and that are adapted for use with a pet door. Further, devices in the prior art do not include an adjustable horizontal support that serves as the floor of the enclosure. Moreover, devices in the prior art fail to disclose a pet enclosure having extendable legs that allow the enclosure to be disposed in an elevated position above the ground outside of the building to which the enclosure is secured. Instead, the prior art devices simply relate to pens or cages of different configurations that confine an animal within a particular area.

In light of the devices disclosed in the prior art, it is submitted that the present invention substantially diverges in design elements from the prior art and consequently it is clear that there is a need in the art for an improvement to existing pet enclosure devices. In this regard the instant invention substantially fulfills these needs.

### SUMMARY OF THE INVENTION

In view of the foregoing disadvantages inherent in the known types of pet enclosures now present in the prior art, the present invention provides a new pet enclosure wherein the same can be utilized for providing convenience for the user when providing a pet with the ability to exit the user's home into an outdoor pet enclosure in order to allow the pet to relieve itself and spend time outside of the home.

It is therefore an object of the present invention to provide a new and improved outdoor pet enclosure device that has all of the advantages of the prior art and none of the disadvantages.

It is another object of the present invention to provide a pet enclosure that allows a pet to exit a home and enter an outdoor pet enclosure without the need for supervision by a pet owner.

Another object of the present invention is to provide a pet enclosure that can be positioned around a pet door and secured to the exterior of a home.

Yet another object of the present invention is to provide a pet enclosure that includes extendable legs so as to allow the enclosure to be disposed at a desired elevation.

A further object of the present invention is to provide a pet enclosure in which a litterbox may be positioned so that odors and litter can remain outdoors, preserving the cleanliness of the home.

An additional object of the present invention is to provide a pet enclosure having an adjustable horizontal support that serves as the floor of the enclosure, wherein the horizontal support can be attached to the sidewalls of the enclosure at a desired height by means of hooks thereon.

Another object of the present invention is to provide an outdoor pet enclosure that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front perspective view of an embodiment of the outdoor pet enclosure of the present invention with the lid in a closed configuration.

FIG. 1B shows a front perspective view of an embodiment of the outdoor pet enclosure of the present invention with the lid in an open configuration.

FIG. 2 shows a perspective view of an embodiment of the outdoor pet enclosure as secured to the exterior of a building.

FIG. 3 shows a perspective view of an embodiment of the outdoor pet enclosure wherein the legs are extended.

### DETAILED DESCRIPTION OF THE INVENTION

Reference is made herein to the attached drawings. Like reference numerals are used throughout the drawings to depict like or similar elements of the outdoor pet enclosure. For the purposes of presenting a brief and clear description of the present invention, the preferred embodiment will be discussed as used for providing a pet with an outdoor enclosure in which a litterbox can be positioned so that the pet can relieve itself outside of the home without supervision by the pet's owner. The figures are intended for representative purposes only and should not be considered to be limiting in any respect.

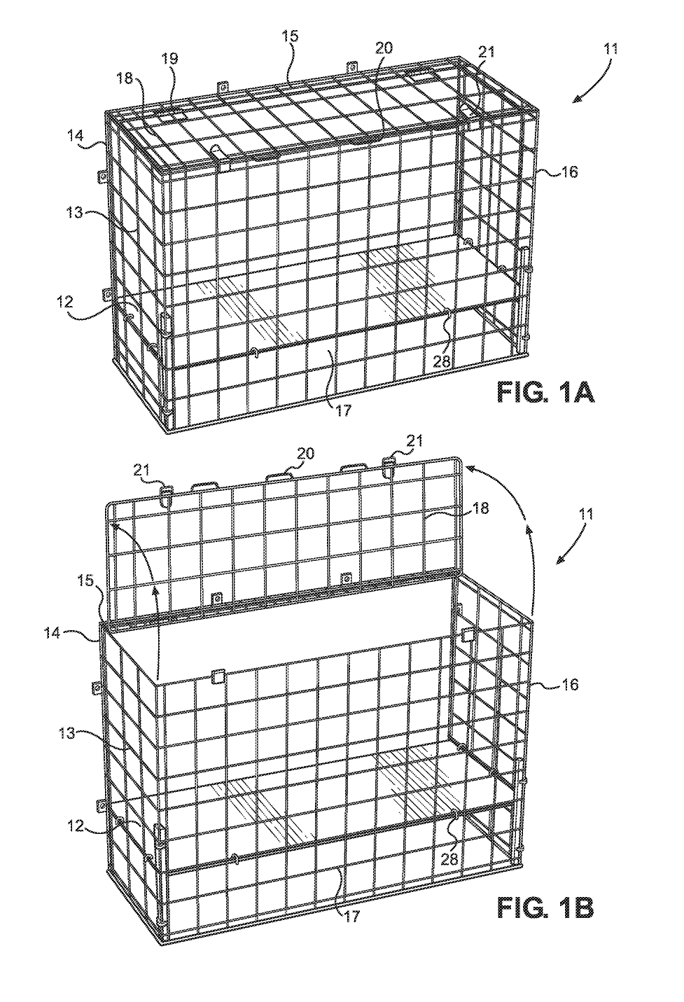

Referring now to FIGS. 1A and 1B, there are shown front perspective views of the pet enclosure of the present invention with the lid in a closed and open configuration, respectively. The outdoor pet enclosure 11 of the present invention includes a substantially rectangular enclosure having a first sidewall 13 opposite a second sidewall 16, wherein the first and second sidewalls 13, 16 are connected to one another by a front wall 17. The rear wall 14 of the pet enclosure 11 is open and is adapted to be positioned against the exterior of a building having a pet door so that the exterior of the building serves as the rear wall of the enclosure, and such that the interior of the pet enclosure 11 is accessible via the pet door. The pet enclosure 11 further includes a top wall 15 that encloses the top of the pet enclosure 11.

The first and second sidewalls 13, 16, the front wall 17, and the top wall 15 each comprise a rectangular shape. In the illustrated embodiment, each wall comprises a wire mesh screen. In some embodiments of the present invention, each wall comprises a tubular frame defining the perimeter of the wall, and a wire screen disposed over the interior area of the frame. The wire screen allows air to flow into and out of the enclosure, and is sized so as to prevent a pet therein from escaping the enclosure. Further, the screen allows a pet to see outside of the enclosure.

In some embodiments of the present invention, each wall of the enclosure is a separate component, and the walls can be secured to one another using a plurality of fasteners, such as clips. The clips are adapted to secure a pair of walls at a right angle, so that the walls can be arranged so as to form a rectangular enclosure as described. The use of multiple separate walls and fasteners allows the device to be easily collapsed for storage and transportation. In alternate embodiments of the present invention, the enclosure comprises a unitary structure, wherein each wall of the enclosure is integrally formed with the other walls. In this way, each wall need not be secured to each other by means of a fastener.

In the illustrated embodiment, the top wall 15 of the pet enclosure 11 includes a lid 18 pivotally secured thereto by means of one or more hinges 19. The lid 18 can be disposed in an open or closed orientation so as to provide access to the interior volume of the enclosure 11. The hinged lid 18 allows the pet owner to remove and clean a litterbox disposed within the pet enclosure 11, or to remove the pet from the pet enclosure 11. The lid 18 is secured in a closed configuration by one or more locking latches 21 disposed on an end of the lid 18 that contacts the upper portion of the front wall 17 of the pet enclosure 11. Thus, the lid 18 can be closed and locked so that a pet inside of the pet enclosure 11 is unable to open the lid 18 and escape the pet enclosure 11. The lid 18 further includes one or more handles 20 thereon to facilitate opening and closing the lid 18.

The enclosure 11 includes an adjustable horizontal support 12 disposed therein that serves as the floor of the pet enclosure 11. The horizontal support 12 is a rectangular panel having a solid, rigid construction. The horizontal support 12 includes a plurality of fasteners 28, such as hooks, about the perimeter or edges thereof. The horizontal support 12 can be disposed at a desired height within the interior volume of the pet enclosure 11 by securing the fasteners 28 on the horizontal support 12 to the first and second sidewalls 13, 16 of the enclosure, and to the front wall 17 thereof. In alternate embodiments of the present invention, separable fasteners may be used that can be removably secured to the adjustable horizontal support 12 and to the first and second sidewalls 13, 16 and front wall 17 of the pet enclosure 11. The horizontal support 12 is preferably adjusted to a height that aligns the horizontal support 12 to the bottom of the pet door on a home. In this way, when the pet exits the home through the pet door, the horizontal support 12 is at substantially the same level as the bottom of the pet door. This allows the pet to smoothly transition from the interior of the house to the outdoor pet enclosure 11 of the present invention.

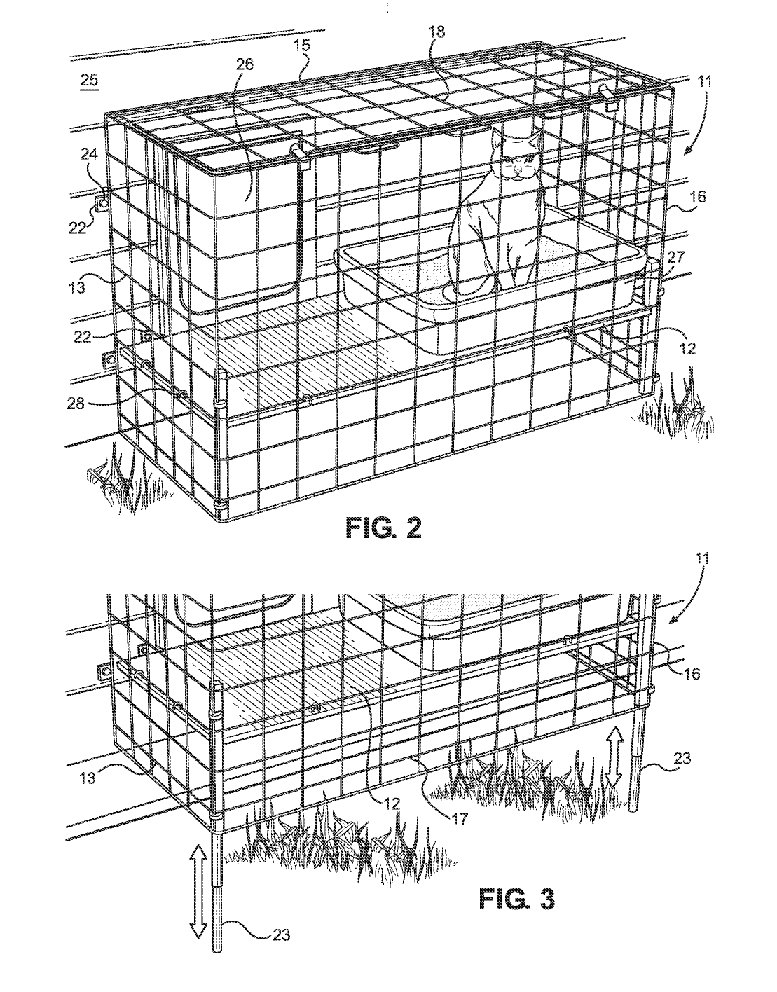

Referring now to FIG. 2, there is shown a perspective view of the pet enclosure as secured to the exterior of a home. The pet enclosure 11 of the present invention is adapted to be secured to the exterior of a home 25 or other building. The open rear wall of the pet enclosure 11 is placed flush against the exterior of the home 25, such that the first sidewall 13 and second sidewall 16 are perpendicular thereto. The pet enclosure 11 is adapted to be positioned over a pet door 26 on the exterior of the home 25. In this way, a pet can exit the home through the pet door 26 and enter the enclosure 11, and the pet is limited to the interior volume of the pet enclosure 11.

The pet enclosure 11 is adapted to provide sufficient space for a litterbox 27 to be enclosed therein. The litterbox 27 can be disposed on the horizontal support 12 within the pet enclosure 11. The pet owner can remove the litterbox 27 from the pet enclosure 11 to empty and clean the litterbox 27 via the lid 18 on the top wall 15 of the pet enclosure 11. Thus, the present invention provides a pet with a place to relieve itself outside of the home, so as to prevent litter from being spilled within a home, and to prevent odors from the litterbox 27 from lingering within the home.

The perimeter of the rear wall of the pet enclosure 11 comprises a plurality of brackets 22 thereon. Each bracket 22 includes an aperture that is adapted to receive a fastener 24, such as a screw or nail. The brackets 22 are adapted to be positioned flush against the exterior wall 25 of a building, such as a home, and a fastener 24 can be inserted through the aperture and into the wall of the building so as to secure the pet enclosure 11 thereto. Further, the horizontal support 12 may include one or more brackets 22 thereon wherein the brackets 22 are adapted to receive fasteners 24 therethrough. In this way, the horizontal support 12 can be secured to the exterior wall 25 of a building to further support and stabilize the horizontal support 12.

Referring now to FIG. 3, there is shown a perspective view of an embodiment of the outdoor pet enclosure wherein the legs are extended. The outdoor pet enclosure 11 of the present invention further includes a pair of extendable legs 23 disposed on a lower portion of the pet enclosure 11 that extend below the pet enclosure 11. Preferably, the legs 23 are positioned at the intersection of the front wall 17 and first sidewall 13, and at the intersection of the front wall 17 and the second sidewall 16. The legs 23 are elongated rods that are disposed vertically, in an upright orientation. The legs 23 can be positioned in a collapsed configuration in which the enclosure can rest directly on the ground, and can alternatively be positioned in an extended configuration wherein the enclosure 11 is elevated above the ground. The legs 23 may be telescopic in order to be adjustable between collapsed and extended configurations. Thus, legs 23 can be extended so as to position the enclosure 11 at the desired height. The appropriate height will depend upon the elevation of the pet door 26 on the wall of the building.

The outdoor pet enclosure allows a pet to spend time outdoors so as to enjoy the fresh air, and to better view their surroundings than can be achieved by looking through a window. Further, the outdoor pet enclosure allows the pet to go outside as it pleases without the owner having to open a door in order to let the pet outside. The pet owner also does not need to supervise the pet, because that the pet is confined to the enclosure and cannot roam freely. Thus, the enclosure ensures the pet's safety while outside of the home. Further, a litterbox can be positioned on the horizontal support within the inside of the pet enclosure so that odors from the litterbox do not linger within the home. Also, if litter is spilled from the litterbox as the pet exits the litterbox or when the pet digs within the litterbox, the litter is not spilled within the home. Thus, the pet enclosure provides users with a means to keep their home clean and sanitary, while also allowing their pet to spend time outdoors.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An outdoor pet enclosure, comprising:
an enclosure having a first sidewall opposite a second sidewall, a front wall connecting said first sidewall and said second sidewall, an open rear wall having a defined perimeter, and a top wall;
an adjustable horizontal support disposed within said enclosure, wherein said adjustable horizontal support is adapted to serve as a floor of said enclosure;
a plurality of brackets disposed about said perimeter of said rear wall, wherein each of said plurality of brackets is adapted to receive a fastener therethrough so as to secure said enclosure to an exterior wall of a building having a pet door thereon.

2) The outdoor pet enclosure of claim 1, wherein said adjustable horizontal support comprises a solid, rectangular panel.

3) The outdoor pet enclosure of claim 1, wherein said enclosure is substantially rectangular.

4) The outdoor pet enclosure of claim 1, wherein each of said first sidewall, said second sidewall, said front wall, and said top wall comprises a wire mesh screen.

5) The outdoor pet enclosure of claim 1, wherein said top wall comprises a lid pivotally secured thereto by means of one or more hinges.

6) The outdoor pet enclosure of claim 5, wherein said lid includes one or more locking latches on an end thereof adapted to secure said lid in a closed configuration.

7) The outdoor pet enclosure of claim 5, further comprising one or more handles on said lid.

8) The outdoor pet enclosure of claim 1, wherein said adjustable horizontal support includes a plurality of fasteners disposed about the perimeter thereof, wherein said plurality of fasteners is adapted to removably secure said adjustable horizontal support to said first sidewall, said second sidewall, and said front wall of said enclosure.

9) The outdoor pet enclosure of claim 1, further comprising a pair of extendable legs disposed on a lower portion of said enclosure.

10) The outdoor pet enclosure of claim 9, wherein said pair of extendable legs are telescopic.

11) The outdoor pet enclosure of claim 1, wherein said first sidewall, said second sidewall, said front wall, and said top wall are integrally formed such that said enclosure comprises a unitary structure.

12) The outdoor pet enclosure of claim 1, wherein said first sidewall, said second sidewall, said front wall, and said top wall are separate structures and can be removably secured to one another by means of a plurality of fasteners.

13) The outdoor pet enclosure of claim 1, wherein said adjustable horizontal support further comprises one or more brackets thereon, wherein each of said one or more brackets is adapted to receive a fastener therethrough so as to secure said enclosure to an exterior wall of a building.
